(19) United States
(12) Patent Application Publication
(10) Pub. No.: US 2013/0283274 A1
(43) Pub. Date: Oct. 24, 2013

(54) METHOD AND SYSTEM FOR DISCOVERING AND ACTIVATING AN APPLICATION IN A COMPUTER DEVICE

(71) Applicant: David Mimran, Tel Aviv (IL)

(72) Inventor: David Mimran, Tel Aviv (IL)

(21) Appl. No.: 13/851,410

(22) Filed: Mar. 27, 2013

Related U.S. Application Data
(60) Provisional application No. 61/617,288, filed on Mar. 29, 2012.

(51) Int. Cl. G06F 9/46

(52) U.S. Cl. CPC G06F 9/46
USPC 718/100

(57) ABSTRACT

The present invention discloses a method for discovering and activating an application in a computer device. The method comprising the steps of: defining at least one application based on its functionality including at least one action which is enabled by the application, identifying a required action to be performed by the user and searching loading a relevant application for the identified action, wherein the process of defining and identifying are performed by at least one processor unit.

### CROSS-REFERENCE TO RELATED PATENT APPLICATIONS

This application claims the benefit of provisional patent application No. 61/617,288 filed on Mar. 29, 2012, which is incorporated herein by reference in its entirety.

### BACKGROUND

1. Technical Field

The present invention relates generally to searching and identifying a computer application, and more particularly, the present invention relates to classifying and organizing computer applications and enabling simple retrieval and identification of computer applications.

2. Discussion of Related Art

The known is the art market place of smart phones applications, such as the apps store of apple provide mainly to techniques for search new applications: search by category or free search by keywords based on definitions provided by the developers of the application. These search techniques are limited to predefined categorizations and definitions which in many cases don't apply to user's needs when trying to search for applications which can perform specific tasks.

### BRIEF SUMMARY

The present invention discloses a method for discovering and activating an application in a computer device. The method comprising the steps of: defining at least one application based on its functionality including at least one action which is enabled by the application, identifying a required action to be performed by the user and searching loading a relevant application for the identified action, wherein the process of defining and identifying are performed by at least one processor unit.

According to some embodiments of the present invention the functionality is further defined by at least one type of object on which the action is applied upon further identifying the object upon which the action is to be applied.

According to some embodiments of the present invention the identifying is achieved by a UI interface on the computer device which enables a user to define the required action to be performed and or the object type on which the action is applied upon.

According to some embodiments of the present invention defining include inserting application description and set of filters.

According to some embodiments of the present invention the defining includes define required interactivity procedure with the user.

According to some embodiments of the present invention the definition of the application is stored in at least one of: application metadata, central applications database, SDK package.

According to some embodiments of the present invention the method further comprising the step of defining a call up activation component by functionality based on required action and object, enabling cross functionality activation between applications.

According to some embodiments of the present invention the searching further include searching the internal memory of the computer device at the first stage and incase the relevant application is not found searching remote application database and downloading the relevant application.

According to some embodiments of the present invention the method further comprises the steps of presenting the user list of available relevant application and enabling him to select at least one application.

According to some embodiments of the present invention the method further comprising the step of ranking the relevant applications.

According to some embodiments of the present invention the identifying is activated within the processing of currently running application.

According to some embodiments of the present invention the method further comprises the step of returning to the originating application.

According to some embodiments of the present invention the method further comprises the step of learning and recording user's usage pattern and characteristics of application in relation to actions or objects.

According to some embodiments of the present invention the method further comprises the step of predicting the next application to be used by the user based on current context of application usage and learned usage pattern and characteristics.

The present invention discloses a system for discovering and activating an application in a computer device. The system comprised of: integration application enabling to define and search at least one application based on its functionality including at least one action which is enabled by the application and a UI interface module on the computer device which enables a user to search, load and activate an application by defining the required action to be performed and or the object type on which the action is applied upon.

According to some embodiments of the present invention the functionality is further defined by at least one type of object on which the action is applied upon further identifying the object upon which the action is to be applied.

According to some embodiments of the present invention the defining of the required action is achieved by a enabling a user to define the required action to be performed and or the object type on which the action is applied upon.

According to some embodiments of the present invention the defining of an application include defining the required interactivity procedure with the user.

According to some embodiments of the present invention the definition of the application is stored in at least one of: application metadata, central applications database, SDK package.

According to some embodiments of the present invention the system further comprises a call up activation component by functionality based on required action and object, enabling cross functionality activation between applications.

According to some embodiments of the present invention the searching further includes searching the internal memory and or storage of the computer device at the first stage and incase the relevant application is not found searching remote application database and downloading the relevant application.

According to some embodiments of the present invention the UI interface further presents the user list of available relevant application and enabling him to select at least one application.

According to some embodiments of the present invention the system further comprises a module for ranking the relevant applications.

According to some embodiments of the present invention the identifying is activated within the processing of currently running application.

According to some embodiments of the present invention the system further comprises a module for learning and recording user's usage pattern and characteristics of application in relation to actions or objects.

According to some embodiments of the present invention the system further comprises a module for predicting the next application to be used by the user based on current context of application usage and learned usage pattern and characteristics.

### BRIEF DESCRIPTION OF THE DRAWINGS

The present invention will be more readily understood from the detailed description of embodiments thereof made in conjunction with the accompanying drawings of which:

FIG. 1 illustrates a high level block diagram of an environment of the present invention, according to some embodiments of the invention;

FIG. 2 illustrates a block diagram illustrating components of integration module, according to some embodiments of the invention;

FIG. 3 shows a flowchart diagram illustrating activity of Application Registering module, according to some embodiments of the invention;

FIG. 4 shows a flowchart diagram illustrating an Application discovery module, according to some embodiments of the invention;

FIG. 5 shows a flowchart diagram illustrating an activity of User Interface (UI), according to some embodiments of the invention;

FIG. 6 shows a flowchart diagram illustrating an activity of UI, according to some embodiments of the invention;

FIG. 7 shows a flowchart diagram illustrating an activity of the Ranking module, according to some embodiments of the invention;

FIG. 8 shows a flowchart diagram illustrating a learning module, according to some embodiments of the invention; and

FIG. 9 shows a flowchart diagram illustrating an activity of context of usage module, according to some embodiments of the invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The term “computerized device” as used herein in this application, is defined as any device with processing capabilities such as a processing device, a computerized mobile device such as Smartphone and a tablet.

Embodiments of the present invention provide a method and system for improving a process of discovering application programs that are published in an electronic market of computer applications, such the Apps stores of Apple. The application programs may be installed on a computerized device or optionally installed on a personal computer. The market place of applications may be provided through any data communication network such as the Internet.

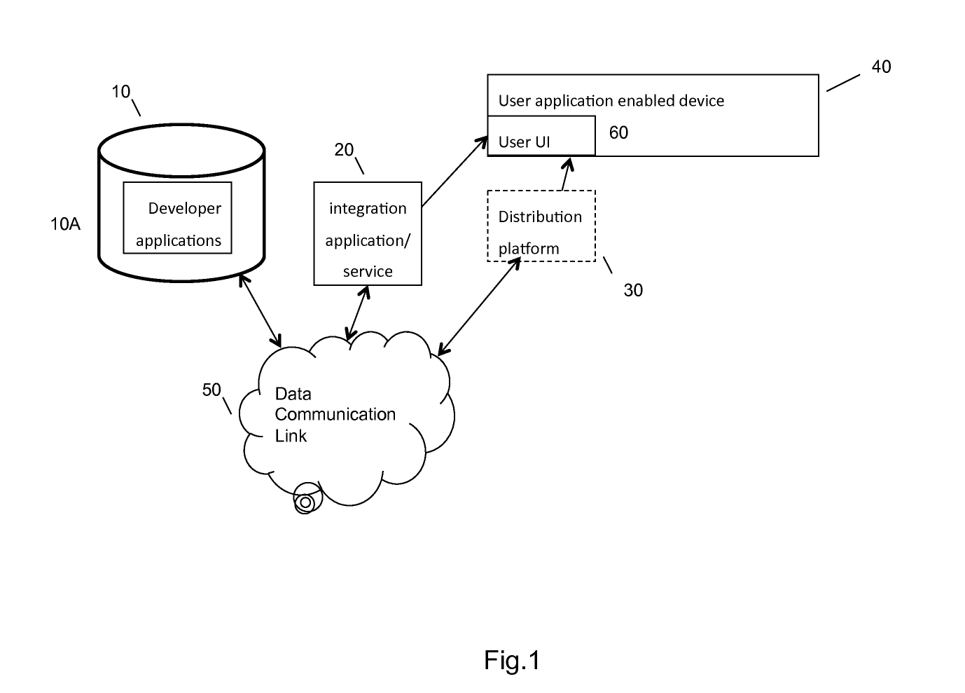

FIG. 1 illustrates a high level block diagram of an environment of the present invention, according to some embodiments of the invention. Various developer applications 10A may be developed by different providers and may reside in a central application database 10. The central application database 10 serves as a basis of application distribution platform 30 such as a marketplace that is provided by Apple's Apps store.

The present invention provides an integration application which can be implemented as a stand-alone service or integrated as part of a distribution platform. An end user of the application is equipped with a personal computerized device 40 such as a Smartphone, a tablet or a personal computer. The personal computerized device 40 optionally includes a designated user interface (UI) for enabling the user to select application according to her or his needs based on the application functionality.

According to alternative embodiments, the required application functionality can be identified by analyzing user actions and behavior. For example, identifying when a user is performing an activity on an object such as trying to open a file which is not recognized by the operating systems, searching for an application that its functionality is managing such a file type.

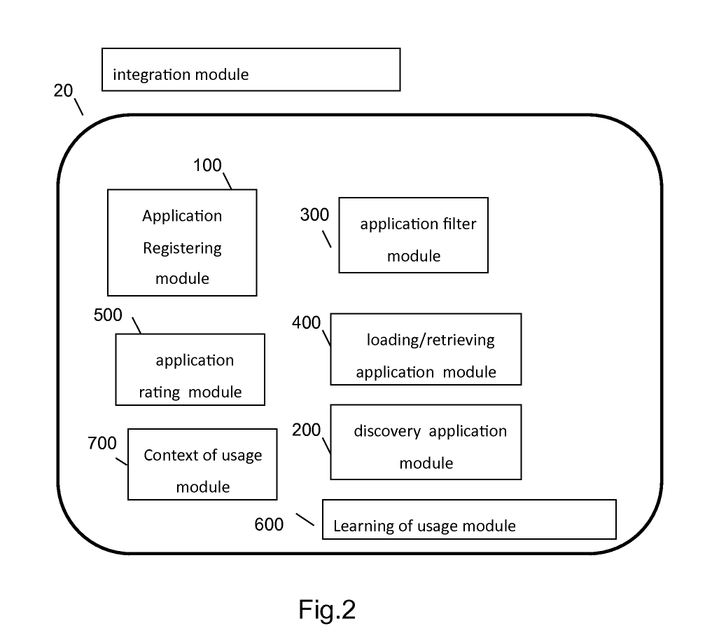

FIG. 2 illustrates a block diagram illustrating the components of an integration module 20, according to some embodiments of the invention. The integration module 20 includes an application registering module 100 to support updating new application by developers, application filter enabling to filter application according to different attributes, retrieving application 400 for downloading selected application to the user personal device 40, discovery application module 200 for locating required application installing and activating it, and optionally ranking module 500 for rating applications by user. According to another other embodiments of the present invention the integration module 20 may further include learning algorithm 600 for identifying usage behavior pattern and context of usage module 700 for predicting the application which the user may wish to use at the current context.

According to some embodiments of the invention, the filtering module 200 may enable to match implicitly or explicitly applications to the user profile including device limitation, geographic location, language, application usage history, current action being taken and current objects being worked on. The matching may check the following parameters: Target operating system and hardware, Target regions, License& pricing terms, usage categories, target language, target computing platform, development stage, required permissions, size of application and user's device memory capacity. According to some embodiments of the present invention the filtering definitions may be controlled by a system administrator of an organization which can define the available application for the organization employees.

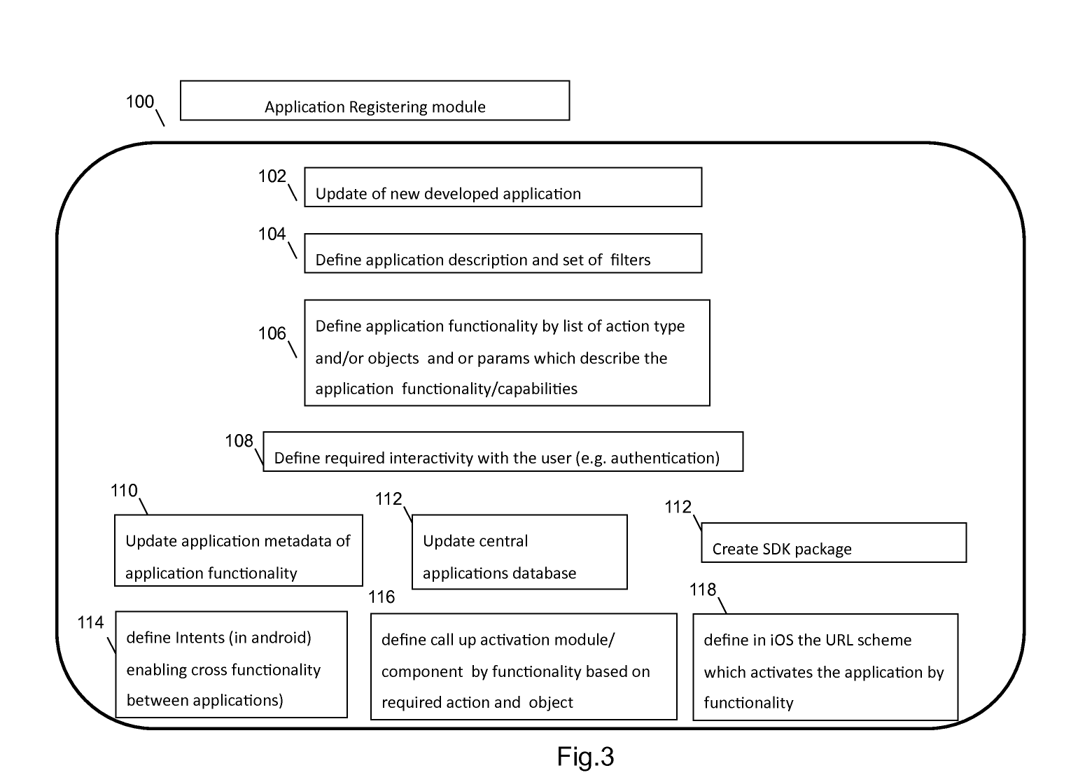

FIG. 3 shows a flowchart diagram illustrating the activity of application registering module 100, according to some embodiments of the invention. Each developer updates (step 102) the application database, with a new application that she or he developed by entering the application installation information. At the next steps of registration the developer enters the application definition (step 104), relevant filters for identifying the application and definition of the application functionality (step 106).

The application functionality is defined by the type of at least one action performed by the application, the params and optionally the type of objects on which the actions are performed. The type of objects may be for example: an image, a video, a Portable Document Format (PDF) file, a contact etc. The type of actions may include: share, print, view, crop, effects for images or video and Short Message Service (SMS), call, send a vcard file, a video call, and a chat.

An action may be a general action that is not related to a specific type of object (such as zoom). The developer may define that the application is capable to perform any action on a specific type of object (e.g. Word application in relation to docs files). The list of type of actions and objects is not limited and developers may suggest adding new types of actions and objects.

At the last step, the developer defines the definitions and the parameters which are related to the user interactivity procedure with the application, such as authentication procedure and parameters. Once all application data is defined by the user, several update procedures take place: updating the central database (step 112) with application definitions and functionality, updating application metadata of application functionality (step 110) and/or creating platform specific definitions (step 114).

The application can be activated by using different implementation other than direct activation: through the operating system of the Smartphone or as a sub-application in another application. To enable such sub-application implementations call up activation module/component are defined by functionality based on the required action and object (step 116). For android based device are defined Intents to enable cross functionality between applications (calling one application functionality from another application) (step 114). For iOS implementation it is suggested to define a URL scheme (step 118). The different implantations described herein for the different operating systems are examples only, any known technique in the art may be used for the same purpose, such technique may include utilizing data network URLs for activating actions on web applications which run under a browsing application.

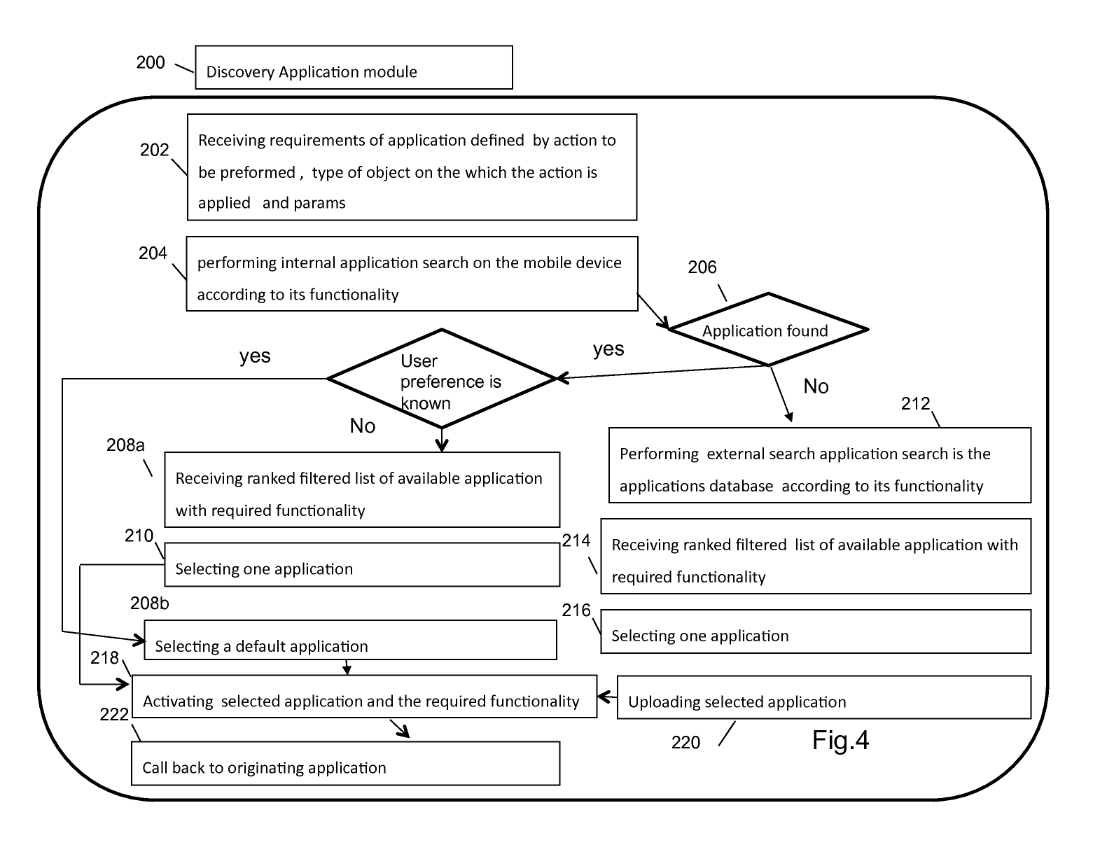

FIG. 4 shows a flowchart diagram illustrating the application discovery module 200, according to some embodiments of the invention. At the first step requirements of requested application are received. The requirements are defined by an action to be performed, type of object on which the action is applied and params (step 202). These requirements may be initiated by a user selection or from a call up application. Based on the requirements, a local search is performed on the local device for an application which is capable to perform the required functionally (step 204), in case one or more relevant applications are identified and user preference is known, a list of ranked applications is provided (step 208a) for selecting one application manually by the user or automatically according to pre-defined rules (210). In case, the user's preference is not known a default application may be selected (step 208b).

In case no internal application is found, an external search is performed in the application database 10, according to the required functionality (step 212). In return to a search query, a ranked list of available applications having the relevant functionality definition is received (step 214).

The ranked list may be presented to the user for selection of a single application (step 216). Alternatively, the selection may be performed automatically according to defined rules and/or user profile. Meaning, for example, one user may prefer to use only a free application, while another user may prefer to use the most updated applications or the application having the most advanced features. After the application was selected it may be downloaded and installed on the user mobile device (step 220). Optionally, through the distribution platform such as apple Apps store, by authenticating the user and performing required financial transaction (step 218) or through direct link to the software developer download site.

According to some embodiments of the present invention the user may be enabled to define association between applications and objects or actions, which can recorded and updated in predefined association list.

Once the desired application is selected and installed on the user device, the user is enabled to activate the application and the required functionality (step 220). The functionality may be applied automatically on the selected object, by the calling application. At the end of the action performed by the application, the control may be returned the calling application (step 222).

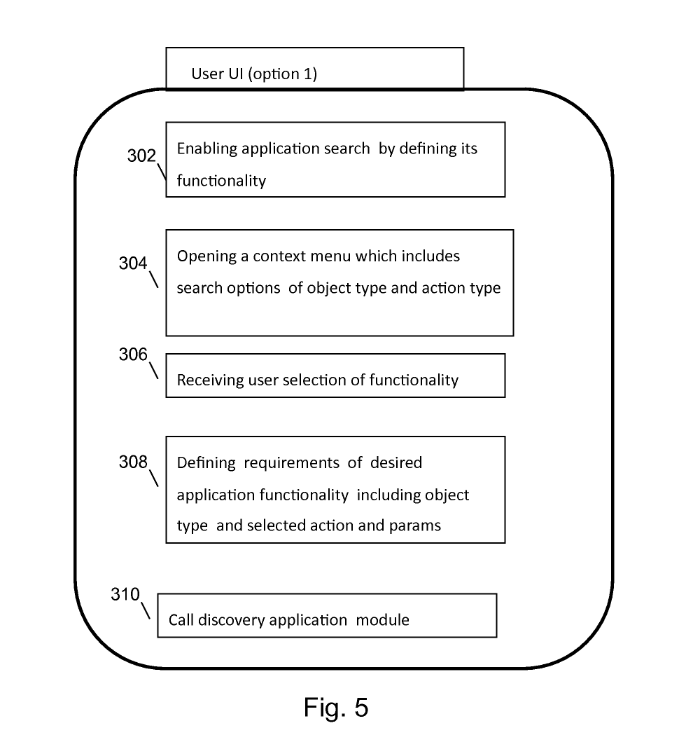

FIG. 5 shows a flowchart diagram illustrating an activity of user UI 60 scenario, according to some embodiments of the invention. According to one UI scenario the user is enabled to define the required functionality by a type of action and a type of object (step 302). The user may select the functionality from a context menu, which present the user with a list of available actions and object types (step 304). Based on the user's selections the functionality requirements for the application discovery module are defined (steps 306, 308). At the last step the application discovery module 200 is activated (step 310).

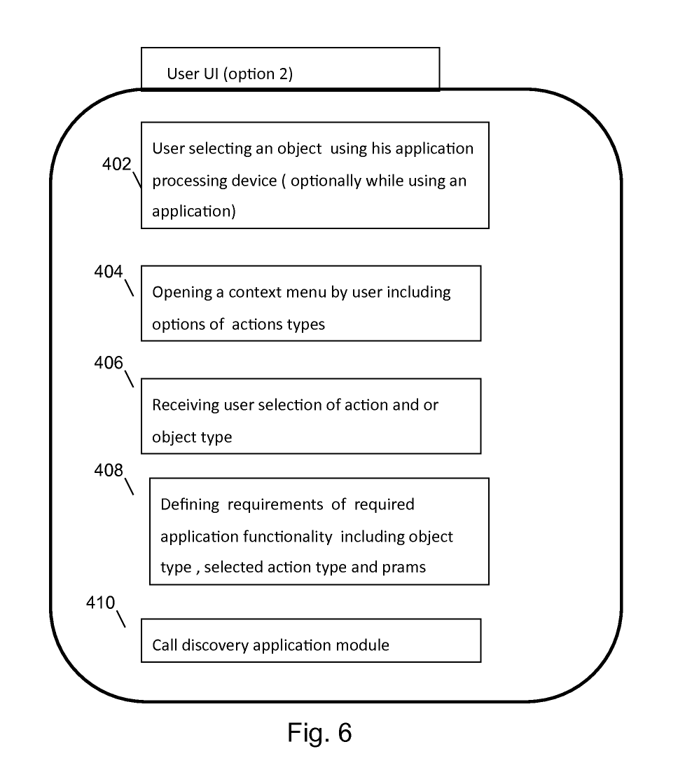

FIG. 6 shows a flowchart diagram illustrating an activity of user UI 60 scenario, according to some embodiments of the invention. According to second UI scenario the search of application may be initiated when the user views or selects a specific object (step 402). For example, the user may browse through an image, a video file or audio files and while doing so the user may wish to perform an operation that will be applied on the browsed objects. For example, a user may wish to change a size of an image. For this purpose the user may click on the object (i.e. the image) or mark it to open a context menu of optional action types which are relevant for the selected object (step 404). Based on received user selection of desired operation (i.e. action), the functionality parameters of action type and object type are defined (step 406). The object type is defined by identifying the type of object selected by the user. At the last step the application discovery module is activated (step 408).

According to some embodiments of the present invention a third scenario for discovering an application is provided. According to this scenario, the discovery application is activated by an application installed on the user device, not necessarily requiring user intervention. This scenario utilizes the SDK integration of capabilities across apps. For example, when an image editing application is required to provide printing capabilities, the developer of this editing application may include the application discovery ability to add the printing functionality on demand. The discovery application will be responsible for automatic discovery and activation of the desired functionality. Optionally the system may download at least some of the candidates application which are presented to the user, prior to user selection, such that, when the user selects one of the candidate application, the application and it's functionality will be already available for use.

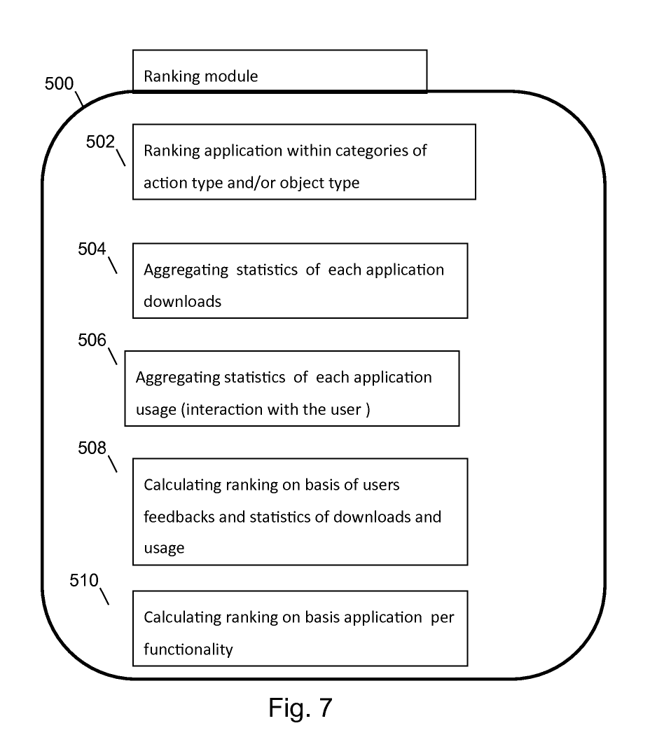

FIG. 7 shows a flowchart diagram illustrating an activity of the ranking module 500, according to some embodiments of the invention. The ranking module 500 enables a user to rank (i.e. rate) an application by categories of action and object types (step 502). The ranking (i.e. rating) may be determined by statistics of application downloads and usage of specific functionality (step 540, 506) by the users. The explicit user ranking (rating) and implicit ranking of downloads can be integrated into a single rate grade (step 508). Optionally, an application may be received different ranking for each functionality or object (step 510). According to some embodiments of present invention it is suggested enable removal of applications form candidate list incase the ranking is bellow predefined threshold. Optionally setting an application as default by user will increase its ranking

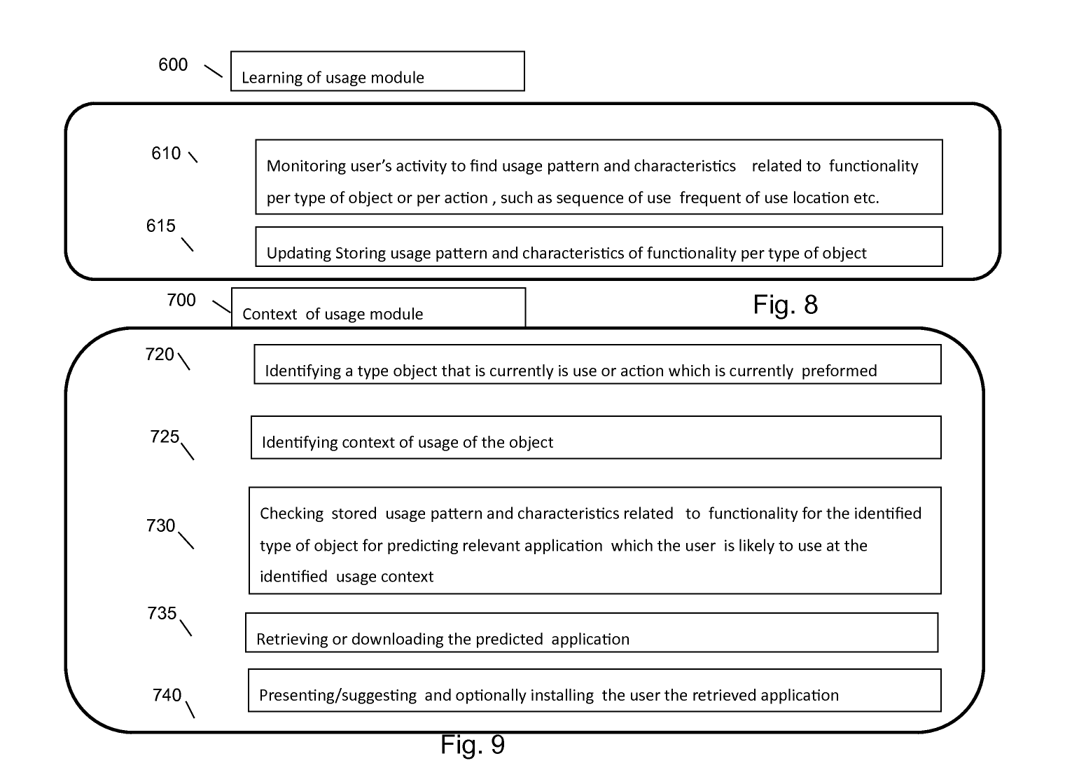

FIG. 8 shows a flowchart diagram illustrating a learning module 600, according to some embodiments of the invention.

According to some embodiments of the present invention, the learning module 600 may monitor user's activity to identify usage pattern and characteristics related to functionality per type of object or per action (step 610). Usage pattern may include identifying order of sequenced actions (e.g. saving picture after capturing it), frequency of usage. Characteristics may include location of usage (Home, office, out door indoor, while driving), time of usage, etc. The usage pattern and characteristics are updated and stored for each a specified period of time (step 615).

FIG. 9 shows a flowchart diagram illustrating an activity of context of usage module, according to some embodiments of the invention.

At the first stage is identified a type object that is currently is use or the current action which is performed (step 720).

At the next step the modules identifies the context of usage of the object or the performed action, such which action or actions were performed or what other objects were used before the current action or object. (step 725).

At this stage of the process the modules checks the stored usage pattern and characteristics related to functionality for the identified type of object for predicting relevant application which the user is likely to use at the identified usage context (step 730).

According to some embodiments of the present invention, the system may aggregate pattern usage of plurality of users creating unified or clustered usage pattern files, hence the user context of use may be compared to a unified usage pattern or clusters of usage patterns of users having common behavior characteristics (or profile). Optionally friends recommendations for application may be available utilizing social network services.

Based on this prediction is retrieved (if already installed or downloaded otherwise) the relevant application (step 735).

The retrieved application may be presented to the user or automatically activated (step 740).

In the above description, an embodiment is an example or implementation of the invention. The various appearances of “one embodiment”, “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Furthermore, it is to be understood that the invention can be carried out or practiced in various ways and that the invention can be implemented in embodiments other than the ones outlined in the description above.

The invention is not limited to those diagrams or to the corresponding descriptions. For example, flow need not move through each illustrated box or state, or in exactly the same order as illustrated and described.

Meanings of technical and scientific terms used herein are to be commonly understood as by one of ordinary skill in the art to which the invention belongs, unless otherwise defined.

What is claimed is:

1. A method for discovering and activating an application in a computer device, said method comprising the steps of:
defining at least one application based on its functionality including at least one action which is enabled by the application;
identifying a required action to be performed by the user and searching loading a relevant application for the identified action.
wherein the process of defining and identifying are performed by at least one processor unit.

2. The method of claim 1 wherein the functionality is further defined by at least one type of object on which the action is applied upon further identifying the object upon which the action is to be applied.

3. The method of claim 1 wherein the identifying is achieved by a UI interface on the computer device which enables a user to define the required action to be performed and or the object type on which the action is applied upon.

4. The method of claim 1 wherein defining include inserting application description and set of filters.

5. The method of claim 1 wherein defining include define required interactivity procedure with the user.

6. The method of claim wherein the definition of the application is stored in at least one of: application metadata, central applications database, SDK package.

7. The method of claim 1 further comprising the step of defining a call up activation component by functionality based on required action and object, enabling cross functionality activation between applications.

8. The method of claim 1 wherein the searching further include searching the internal memory of the computer device at the first stage and incase the relevant application is not found searching remote application database and downloading the relevant application.

9. The method of claim 1 further comprising the steps of presenting the user list of available relevant application and enabling him to select at least one application.

10. The method of claim 1 further comprising the step of ranking the relevant applications;

11. The method of claim 1 wherein the identifying is activated within the processing of currently running application.

12. The method of claim 11 further comprising the step of returning to the originating application.

13. The method of claim 1 further comprising the step of learning and recording user's usage pattern and characteristics of application in relation to actions or objects.

14. The method of claim 13 further comprising the step of predicting the next application to be used by the user based on current context of application usage and learned usage pattern and characteristics.

15. A system for discovering and activating an application in a computer device, said system comprised of:
An integration application enabling to define and search at least one application based on its functionality including at least one action which is enabled by the application; and
A UI interface module on the computer device which enables a user to search, load and activate an application by defining the required action to be performed and or the object type on which the action is applied upon.

16. The system of claim 15 wherein the functionality is further defined by at least one type of object on which the action is applied upon further identifying the object upon which the action is to be applied.

17. The system of claim 15 wherein the defining of the required action is achieved by a enabling a user to define the required action to be performed and or the object type on which the action is applied upon.

18. The system of claim 15 wherein defining of an application include defining the required interactivity procedure with the user.

19. The system of claim 15 wherein the definition of the application is stored in at least one of: application metadata, central applications database, SDK package.

20. The system of claim 15 further comprising a call up activation component by functionality based on required action and object, enabling cross functionality activation between applications.

21. The system of claim 15 wherein the searching further includes searching the internal memory and or storage of the computer device at the first stage and incase the relevant application is not found searching remote application database and downloading the relevant application.

22. The system of claim 15 wherein the UI interface further presents the user list of available relevant application and enabling him to select at least one application.

23. The system of claim 15 further comprising a module for ranking the relevant applications.

24. The system of claim 15 wherein the identifying is activated within the processing of currently running application.

25. The system of claim 15 further comprising a module for learning and recording user's usage pattern and characteristics of application in relation to actions or objects.

26. The system of claim 15 further comprising a module for predicting the next application to be used by the user based on current context of application usage and learned usage pattern and characteristics.
